(19) United States
(12) Patent Application Publication
(10) Pub. No.: US 2006/0098645 A1
(43) Pub. Date: May 11, 2006

(54) System and method for providing client identifying information to a server

(76) Inventor: Lev Walkin, Palo Alto, CA (US)

Correspondence Address: WHITE & CASE LLP;PATENT DEPARTMENT, 1155 AVENUE OF THE AMERICAS, NEW YORK, NY, 10036, US

(21) Appl. No.: 10/984,348

(22) Filed: Nov. 9, 2004

(51) Int. Cl. H04L 12/56

(52) U.S. Cl. 370/389

(57) ABSTRACT

A system for providing client identifying information to a server includes a tagger at an intelligent intermediate device configured to create at least one tagged packet including client identifying information to be sent to the server, and an interceptor configured to derive the client identifying information from the at least one tagged packet and to provide the client identifying information to an application at the server. In one embodiment, the tagger is configured to insert the client identifying information into the data portion of the at least one tagged packet. In another embodiment, the tagger is configured to insert the client identifying information into a protocol header of the at least one tagged packet.

### FIELD OF THE INVENTION

This invention relates generally to electronic networks and relates more particularly to a system and method for providing client identifying information to a server.

### BACKGROUND

In many client-server networks, a client and a server do not communicate directly, but through various intermediate devices. Some of these devices, such as web proxies, terminate a connection from the client and open a new connection to the server. When an intermediate device establishes a connection with a server to request content on behalf of a client, the server may not be able to determine the original source of the request or other attributes of the source such as its Internet Protocol (IP) address, in the same way that it could learn such attributes if there were no intermediate device. Often, the server only sees that the immediate source of the request is the intermediate device.

There are situations in which a server should know the IP address of the original source of a request for content, which is typically a client. For example, the server may want to perform an authorization process based on the IP address of the client, or an application at the server may want to use the client IP address as a unique visitor identifier to estimate the effectiveness of marketing efforts. In another example, a server may want to vary the content sent to a client according to the client's location. In such a case, the server needs to know the IP address of the client to send it the appropriate content.

A server may also use the client's IP address for security purposes. For example, the server may be configured to send certain data only to certain trusted clients, or may be programmed to not respond to requests from clients in certain regions or countries. However, for these security measures to be effective, the server should know the IP address of the client that is the initial requester.

A known technique used by some intermediate devices for informing a server of the IP address of a client is using an X-Forwarded-For header line in an HTTP protocol, or another header with a similar purpose. This header line contains the IP address of the original source, and may also contain the addresses of other intermediate devices that exist between the original source and this intermediate device. In this technique, the server software is configured to use this list of IP addresses for various purposes. A drawback of this technique is that it is applicable within only a few protocols, such as HTTP, and can't be used with other protocols, such as FTP. A second drawback is that for cryptographically secure connections (e.g., connections using SSL techniques) the proxy will only see encrypted HTTP-level data and will not be able to modify the appropriate header line. A third drawback is that the header can be forged by an unauthorized client. A fourth drawback is a lack of transparency: the server software many need to be reconfigured or reprogrammed to interpret and use the new header, and such changes to servers can be costly or impossible.

Another known technique for providing the IP address of a client to a server is a request-response service that actively queries an intermediate device about its knowledge of the client. In this technique, the server software is configured to connect to the intermediate device and request the client's IP address. A drawback of this technique is that the request-reply cycle takes time and can create delays, particularly where the server should know the client's IP address prior to preparing content for that client. A further drawback of this technique is a lack of transparency: the server must be programmed to initiate these queries and architected to cope with the delay until an answer arrives.

Another known technique for providing client IP addresses to a server is an offline transfer of the address information from an intermediate device to the server. This technique requires the intermediate device to keep a log of the client connections. This technique may be useful for marketing research purposes, but it does not allow the server to use a client's IP address for authorization purposes or to customize content for the client. A drawback of this technique is a lack of transparency with respect to the server data management processes.

### SUMMARY

A system for providing client identifying information to a server includes a tagger at an intelligent intermediate device that creates at least one tagged packet for inclusion in a server communication. The server preferably includes an interceptor that derives the client identifying information from the at least one tagged packet and provides the client identifying information to an application at the server. In one embodiment, the interceptor provides the client identifying information to the application by intercepting a call from the application to an operating system of the server requesting the identity of the source of the communication, and replying with a response that includes the client identifying information in place of the identity of the source of the communication. The interceptor is further configured to provide the original communication data to the application.

In one embodiment, the tagger is configured to concatenate the client identifying information with communication data and packetize the resulting data, producing at least one tagged packet that includes client identifying information in a data field. In another embodiment, the tagger is configured to create at least one tagged packet by including the client identifying information into a protocol header of the at least one tagged packet.

A method for providing client identifying information to a server includes, creating at least one tagged packet that includes client identifying information as a packet to be included in a communication, sending the tagged packet as part of the communication to the server, recognizing the at least one tagged packet in the communication, deriving the client identifying information from the at least one tagged packet, and providing the client identifying information to the application. Providing the client identifying information to the application preferably includes intercepting a call from the application to an operating system of the server requesting the identity of the source of the communication, and replying to the intercepted call with a response that includes the client identifying information in place of the identity of the source of the communication. The method further includes providing the original communication data to the application at the server.

### BRIEF DESCRIPTION OF THE DRAWINGS

FIG. 1A is a block diagram of one embodiment of an electronic network, in accordance with the present invention;

FIG. 1B is a block diagram of another embodiment of an electronic network, in accordance with the invention;

FIG. 2 is a block diagram of one embodiment of the intelligent intermediate device of FIG. 1A, in accordance with the invention;

FIG. 3A is a diagram of a tagged packet, in accordance with the preferred embodiment of the invention;

FIG. 3B is a diagram of another embodiment of a tagged packet, in accordance with the invention;

FIG. 4 is a block diagram of one embodiment of the source-identifying server of FIG. 1A, in accordance with the invention; and

FIG. 5 is a flowchart of method steps for deriving client identifying information, in accordance with one embodiment of the invention.

### DETAILED DESCRIPTION OF THE DRAWINGS

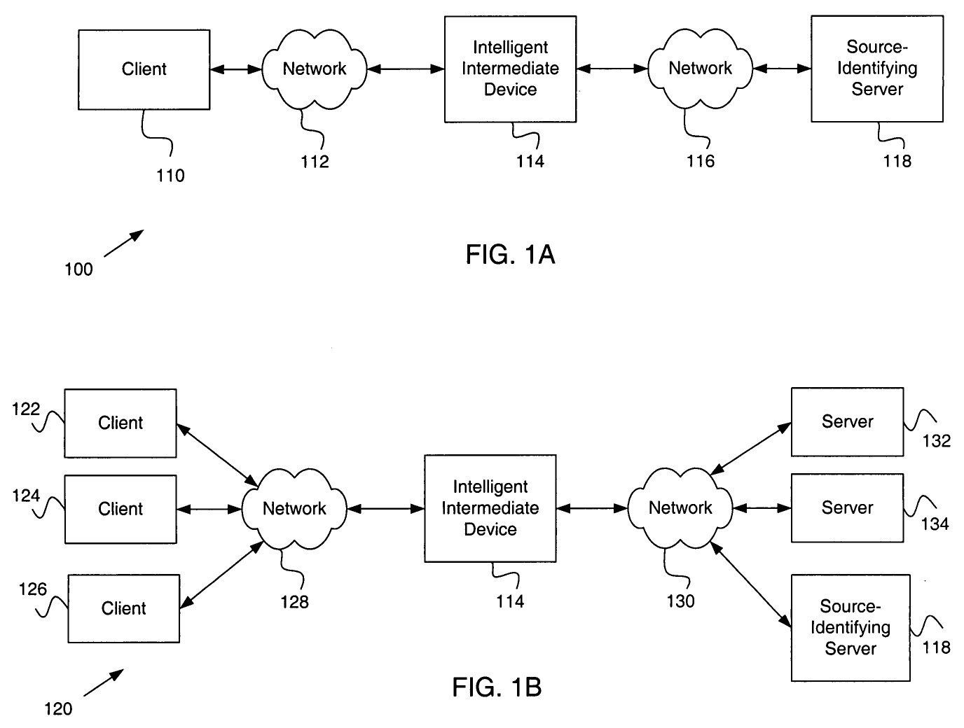

FIG. 1A is a block diagram of one embodiment of an electronic network 100, in accordance with the invention. Network 100 includes, but is not limited to, a client 110, a network 112, an intelligent intermediate device 114, a network 116, and a source-identifying server 118. Client 110 sends a client communication, which typically contains a request for content, through network 112 to intelligent intermediate device 114. Intelligent intermediate device 114 terminates the connection from client 110, and then sends a server communication, which typically includes the request for content, through network 116 to source-identifying server 118 over another connection. Source-identifying server 118 generates the content according to the request, and then sends the generated content to intelligent intermediate device 114, which then sends the content to client 110. In the FIG. 1A embodiment, client 110, intelligent intermediate device 114, and source-identifying server 118 communicate according to a protocol stack that includes TCP/IP (Transmission Control Protocol over Internet Protocol) at the transport and network layers. Intelligent intermediate device 114 may be any type of networking device that establishes separate connections between a client and a server, for example a proxy, any type of surrogate server, a server load balancer, and a Secure Socket Layer (SSL) gateway. Other examples of such intermediate devices are described in U.S. patent application Ser. No. 09/534,321, entitled “Method for High-Performance Delivery of Web Content,” the disclosure of which is hereby incorporated by reference in its entirety.

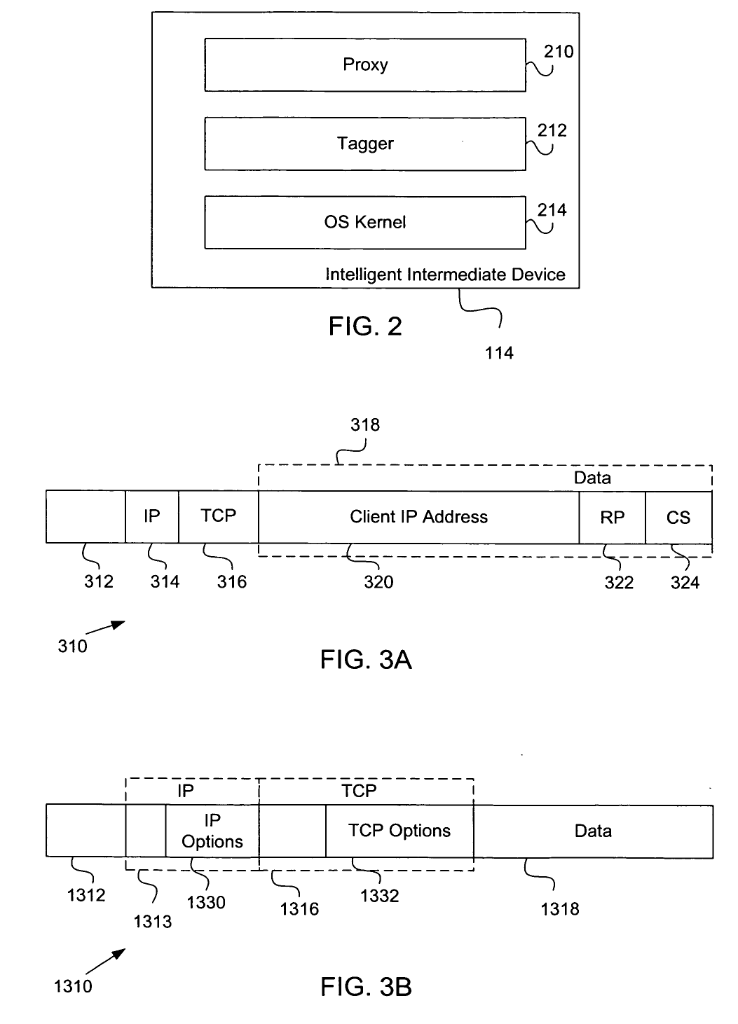

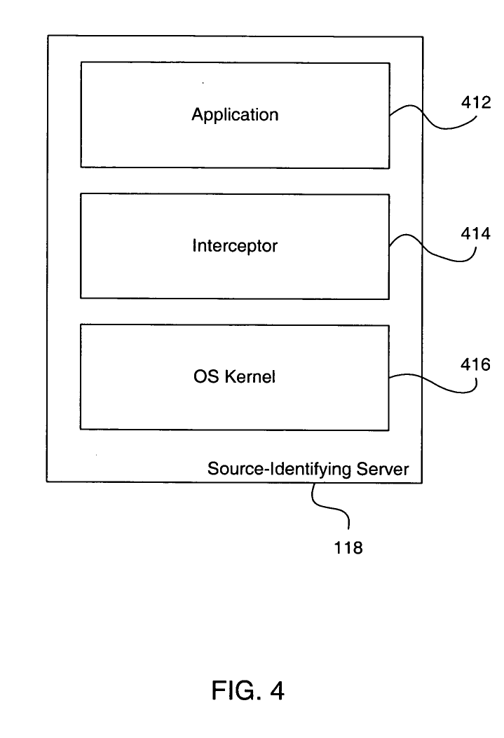

Intelligent intermediate device 114 may modify the server communication sent to source-identifying server 118 to include identifying information of client 110. Intelligent intermediate device 114 may modify the original communication data to include the client identifying information, or modify protocol headers of the server communication to include the client identifying information, or some combination of these. The contents and functionality of a preferred intelligent intermediate device 114 are described below in conjunction with FIG. 2. A preferred source-identifying server 118 derives the identifying information of client 110 from the server communication and provides it to the appropriate application. The contents and functionality of source-identifying server 118 are described below in conjunction with FIG. 4.

FIG. 1B is a block diagram of another embodiment of an electronic network 120, in accordance with the invention. Network 120 includes, but is not limited to, a client 122, a client 124, a client 126, a network 128, intelligent intermediate device 114, a network 130, a server 132, a server 134, and source-identifying server 118. In the FIG. 1B embodiment, intelligent intermediate device 114 can receive a client communication through network 128 from any one of clients 122, 124, and 126. For each client communication, intelligent intermediate device 114 determines which of server 132, server 134, or source-identifying server 118 should receive information, such as a request for content, on behalf of the client and then determines whether a server communication should include client identifying information. For information intended for source-identifying server 118, intelligent intermediate device 114 prepares a server communication that includes client identifying information. For information intended for server 132 or 134, intelligent intermediate device 114 prepares a server communication that does not include client identifying information, since server 132 and server 134 are not source-identifying servers.

FIG. 2 is a block diagram of one embodiment of intelligent intermediate device 114 of FIG. 1A, in accordance with the invention. Intelligent intermediate device 114 includes, but is not limited to, a proxy 210, a tagger 212, and an OS kernel 214. Proxy 210 acts as a proxy for source-identifying server 118, receiving and responding to requests for content on behalf of source-identifying server 118. For content that is not cached at intelligent intermediate device 114 or must be retrieved from source-identifying server 118, proxy 210 establishes a connection to source-identifying server 118 to request the desired content.

Client 110 establishes a connection with intelligent intermediate device 114 and sends a request for content to intelligent intermediate device 114. In establishing the connection, client 110 communicates identifying information, which may include its IP address, to intelligent intermediate device 114. Whenever there is a direct connection between one endpoint (such as client 110) and another (such as intermediate device 114) it is a built-in property of the IP protocol that each endpoint can learn the IP address of the other. However, the specific mechanism by which this happens (a standard, dedicated field in the IP header) cannot also be used to record the identity of other hosts not involved as direct endpoints in the connection. Proxy 210 terminates the connection from client 110 and prepares a server communication, including the request for content, to be sent to source-identifying server 118. Tagger 212 modifies the server communication to include identifying information of client 110, creating tagged data, which is then packetized by OS kernel 214 to produce a tagged data stream. Techniques for creating a tagged data stream that includes client identifying information are described below in conjunction with FIGS. 3A & 3B. Tagger 212 may be implemented as hardware, software, firmware, or a combination. In an implementation of tagger 212 that includes software, the software may be implemented within OS kernel 214, within a system's network stack software, within a non-kernel application, or a combination. In another embodiment of intelligent intermediate device 114 the functionality of tagger 212 is incorporated into proxy 210.

FIG. 3A is a diagram of a tagged packet 310, in accordance with the preferred embodiment of the invention. Tagged packet 310 is the first data-bearing packet in a tagged data stream. In this embodiment, tagger 212 concatenates the client identifying information in front of the original server communication data, then forwards the resulting tagged data to OS kernel 214, which packetizes the tagged data to form the tagged data stream. Tagged packet 310 includes, but is not limited to, a data link header 312, an IP header 314 including an IP options field (not shown), a TCP header 316 including a TCP options field (not shown), and a data field 318. Client identifying information, including a client IP address 320, a recognition pattern 322, and a checksum 324, resides in data field 318 of tagged packet 310. Client IP address 320 is the IP address of client 110 formatted in a way that source-identifying server 118 is configured to recognize, e.g., a number or a name. The formatting scheme includes recognition pattern 322 and checksum 324, and may include other fields (not shown). The recognition pattern 322 assists source-identifying server 118 in recognizing tagged packet 310 as a packet that is part of a tagged data stream. Checksum 324 assists source-identifying server 118 in verifying that the client identifying information has not been corrupted.

In another embodiment, recognition pattern 322 and checksum 324 may be replaced or supplemented by a cryptographic signature that allows source-identifying server 118 to recognize that the data stream that tagged packet 310 belongs to has been tagged, to guard against corruption, and to further authenticate the client identifying information as having been inserted by an authorized or trusted entity. In this embodiment, public key cryptographic methods and digital signature technology may be used.

In another embodiment, one or both of recognition pattern 322 and checksum 324 are omitted. For example, checksum 324 may be omitted when the chance of corruption is deemed to be very low. Recognition pattern 322 may be omitted when source-identifying server 118 can otherwise determine that the data stream has been tagged to include client identifying information. If both recognition pattern 322 and checksum 324 are omitted, source-identifying server 118 may be configured to recognize intelligent intermediate device 114 based on intelligent intermediate device 114's IP address, and to assume that data streams from intelligent intermediate device 114 always include client identifying information. Source-identifying server 118 may alternately be configured to receive tagged data streams from intelligent intermediate device 114 on a different TCP/IP port than untagged data streams from other devices.

Returning to FIG. 3A, client IP address 320 and its associated data fields for recognition pattern 322 and checksum 324 are shown as the initial data within a first data-bearing tagged packet 310 of the tagged data stream. It is recognized that the standard processes of TCP/IP fragmentation and packetization may instead cause the client identifying information to be partitioned over the first several data-bearing packets of the tagged data stream, notably when there is more client identifying information than can fit within a single packet. For example, tagged packet 310 may pass through an IP router in network 116 that fragments tagged packet 310 into two smaller packets, each containing a portion of the client identifying information in tagged packet 310. Alternatively, data field 318 may include the client identifying information and a portion of the original communication data, depending on the size of tagged packet 310.

When server communications including client identifying information are packetized according to the FIG. 3A embodiment to create the tagged data stream, source-identifying server 118 does not necessarily require modifications to its operating system kernel to successfully derive the client identifying information. Tagger 212 can simply write the client identifying information directly into the data stream as additional communication data ahead of the original communication data. The content and format of the original communication data does not matter and thus it may, for example, be encrypted.

FIG. 3B is a diagram of another embodiment of a tagged packet 1310, in accordance with the invention. In this embodiment, tagger 212 modifies the protocol headers of the packetized server communication to create the tagged data stream. Tagged packet 1310 includes, but is not limited to, a data link header 1312, an IP header 1313 including an IP options field 1330, a TCP header 1316 including a TCP options field 1332, and a data field 1318. In this embodiment, the identifying information of client 110 is inserted into IP options field 1330 or TCP options field 1332. In this embodiment, an operating system kernel of source-identifying server 118 must be configured to identify and remove the client identifying information from the appropriate header options field. In this embodiment, the client identifying information inserted into IP options field 1330 or TCP options field 1332 may be formatted similarly to that shown in FIG. 3A, as a client IP address with a recognition pattern and a checksum. In other embodiments, either or both of the recognition pattern and the checksum may be omitted and a cryptographic signature or other auxiliary data may be used to assist source-identifying server 118 in reliably and securely deriving the provided client identifying information.

In another embodiment of tagged packet 1310, some or all of the client identifying information and associated auxiliary data may be encoded in fixed fields within IP header 1313 other than IP options field 1330, or in fixed fields within TCP header 1316 other than TCP options field 1332. For example, the TCP “urgent” flag (one bit in TCP header 1316) and “urgent” pointer (an additional 16 bits in TCP header 1316) may be used to indicate that this packet belongs to a tagged data stream including client identifying information, and to encode some portion of the client identifying information or auxiliary data. Fixed fields in a packet header can be used in this manner when there is otherwise no chance that source-identifying server 118 would misinterpret them and handle the tagged data stream incorrectly. For example, a web server is often not designed to expect or process TCP urgent data and so using the urgent bit and urgent pointer for a non-standard purpose, such as encoding client identifying information, will be acceptable in various web contexts.

Although only one tagged packet 1310 is shown, the client identifying information may be fragmented over several tagged packets depending on the size of IP options field 1330, TCP options field 1330, the connection between intelligent intermediate device 114 and network 116, or the capabilities of nodes and connections within network 116.

FIG. 4 is a block diagram of one embodiment of source-identifying server 118 of FIG. 1A, in accordance with the invention. Source-identifying server 118 includes, but is not limited to, an application 412, an interceptor 414, and an operating system (OS) kernel 416. Although FIG. 4 shows application 412 and interceptor 414 as entirely separate from OS kernel 416, in other embodiments application 412 and/or interceptor 414 may be partially integrated with OS kernel 416. However, application 412 is typically not a kernel component but makes use of kernel services through mechanisms such as system calls and interrupts. Application 412 is configured to provide content to remote devices such as intelligent intermediate device 114. Exemplary implementations of application 412 include an HTTP application, a SMTP application, or a FTP application. Interceptor 414 is configured to intercept communications received from intelligent intermediate device 114 and determine whether any of the data streams have been processed by tagger 212 to include client identifying information. In this embodiment of source-identifying server 118, interceptor 414 is configured to recognize tagged data streams produced by tagger 212 in accordance with the embodiment of FIG. 3A. When interceptor 414 recognizes tagged data streams, it derives client identifying information from the tagged data streams. Interceptor 414 then provides the client identifying information to application 412 or provides means for application 412 to query for the client identifying information. Interceptor 414 also reconstructs the original communication data of the data stream as it was prior to processing by tagger 212. For example, interceptor 414 reconstructs the original request message prepared by proxy 210 prior to processing by tagger 212. Interceptor 414 then sends the reconstructed original communication data to application 412.

In one embodiment, interceptor 414 only looks for tagged data streams on connections from a trusted source. For example, intelligent intermediate device 114 may be a known proxy for source-identifying server 118 and is a trusted source. Other network devices (not shown) may open connections with source-identifying server 118, and if those devices are not trusted sources, interceptor 414 will not look at incoming packets on those connections.

In a typical server, an application calls to an OS kernel to fetch a next available connection from a new connections queue in the OS kernel. For example, the application may invoke the “accept” system call which is the most common interface for delivering new connections to an application. The OS kernel responds to the accept call with the identity of the connection (e.g., socket number), after which the application may invoke other system calls, such as “read,” using the connection identity to retrieve data from the connection for processing. The application may also send data on the connection to the remote device, for example intelligent intermediate device 114.

Normally, when the OS kernel responds to the accept call with a new connection, it also supplies the identity (e.g., IP address) of the connected remote device. Alternatively, an application may use an explicit query system call to ask the OS kernel for attributes of the connection such as the identity of the connected remote device. System calls such as accept or system calls that query connection properties typically include an address of a buffer where the OS kernel should write the identifying information of the connected remote device. Normally, the OS kernel responds to the call and writes the identifying information of the connected remote device into the buffer. The particular format of the calls to the OS kernel depends on the particular implementation of the OS kernel. The accept call, while commonly used, is merely an example of an interface that may be used by an application to access and utilize network connections.

In source-identifying server 118, application 412 calls to OS kernel 416 to fetch a next available connection from a new connections queue in OS kernel 416. Interceptor 414 intercepts this call, and sends its own call to OS kernel 416 for the next available connection. If there are any available connections, OS kernel 416 responds with the connection identity of one such connection and the IP address of the connected remote device. Interceptor 414 may also have an internally stored queue of “pending” connections, where the queue records the connection identity and the IP address of the connected remote device. Pending connections are connections previously delivered to interceptor 414 by OS kernel 416 but not yet reported to application 412. For either a freshly reported new connection or a pending connection, interceptor 414 makes another system call to OS kernel 416 to read incoming data from the new connection. Interceptor 414 looks at the incoming data on the connection to determine whether the data stream has been tagged with client identifying information. In this embodiment, interceptor 414 uses a “PEEK” form of a read system call that inspects pending data on a connection in kernel buffers but does not remove the data from the kernel buffers.

If interceptor 414 determines that the data stream has not been tagged with client identifying information, for example does not see the correct recognition pattern at the correct position in the data, interceptor 414 forwards the new connection identity and the IP address of the connected remote device to application 412 exactly as interceptor 414 received them from OS kernel 416. If interceptor 414 recognizes an appropriate recognition pattern or other marker in the incoming data and sees that the encoded client identifying information is present in the incoming data in its entirety, interceptor 414 re-reads the client identifying information from the incoming data using a non-PEEK version of the read system call so that the client identifying information is removed from OS kernel 416's pending data queue. Interceptor 414 then forwards the new connection identity to application 412 and fills the buffer provided by application 412 with the derived client identifying information rather than the address of the connected remote device that was reported by OS kernel 416. Interceptor 414 also stores an association between the connection identity and the derived client identifying information within internal storage, and marks this record as non-pending.

If interceptor 414 receives a new connection from OS kernel 416 at a time when there is insufficient pending data in OS kernel 416's buffers for this connection to determine whether this data stream has been tagged or not, or that it is tagged but that the client identifying information is incomplete, the interceptor 414 does not return the new connection identity to application 412 but records the connection identity and address of the connected remote device in internal storage, and marks the record as pending.

Application 412 may also call to OS kernel 416 to request the identity of the remote device on the other end of the connection. This may be part of the original call for the next available connection as in “accept” or may be a separate call, depending on the implementation of OS kernel 416. Interceptor 414 intercepts the call, which includes the address of a buffer for the identity of the remote device. Interceptor 414 consults its internal store for a record matching the provided connection identity and associated client identifying information. If such a record is found, interceptor 414 fills the buffer with the stored derived client identifying information and returns this to application 412. If such a record is not found, interceptor 414 forwards the call to OS kernel 416 for the identity of the remote device and OS kernel 416 responds by writing the identity of intelligent intermediate device 114 into the buffer. In this embodiment, interceptor 414 transparently provides the client identifying information to application 412 since application 412 is not aware that the response it receives to its call has been modified by interceptor 414.

Other embodiments of interceptor 414 may include alternate implementation details. Depending on the details of the OS system call API and the extent to which fully transparent support is required, there may be numerous system calls that must be intercepted by interceptor 414. For example, interceptor 414 may use a non-PEEK system call to read pending data if it is configured to buffer non-tagged data it receives for later retrieval by application 412. Other embodiments of interceptor 414 also may require that system calls associated with data reading be intercepted as well, so that interceptor 414 has an opportunity to return data from internal storage where necessary.

Application 412 may then use the identifying information of client 110 in the buffer for any purpose. For example, application 412 may use the identity of client 110 to determine appropriate content in response to the request, or may determine whether client 110 is authorized to receive the requested content. Application 412 may also add the identity of client 110 to a log of unique visitors.

In one embodiment, interceptor 414 is a shared library that is preloaded during the startup sequence of application 412, so that selected system calls are intercepted by the library code. A particular implementation of interceptor 414 may need to be configured to interface with each particular implementation of application 412 (e.g., HTTP web server or SMTP mail server) and OS kernel 416 (e.g., Windows or Linux). For instance, each particular implementation of OS kernel 416 answers to uniquely formatted calls. Techniques for configuring interceptor 414 to interface with particular implementations of application 412 and OS kernel 416 are known in the art.

In this embodiment of source-identifying server 118, no changes to application 412 or OS kernel 416 are required to provide the identity of client 110 to application 412. This allows source-identifying server 118 to be easily configured to include interceptor 414. Also, cryptographically secure data received by source-identifying server 118 is not affected by the functions of interceptor 414. In another embodiment, the functionality of interceptor 414 may be implemented by direct modifications to the code of application 412.

To process tagged packets such as tagged packet 1310 of FIG. 3B, in which the client identifying information is embedded within low-level packet headers, embodiments of source-identifying server 118 typically require some kernel-level access. An alternative embodiment of interceptor 414 may be a loadable kernel module configured to receive system calls directly from application 412, and then either forward the original system calls to OS kernel 416 or modify them as set forth above. In another embodiment, OS kernel 416 is directly modified so that the original implementations of the system calls are upgraded to have the functionalities of interceptor 414.

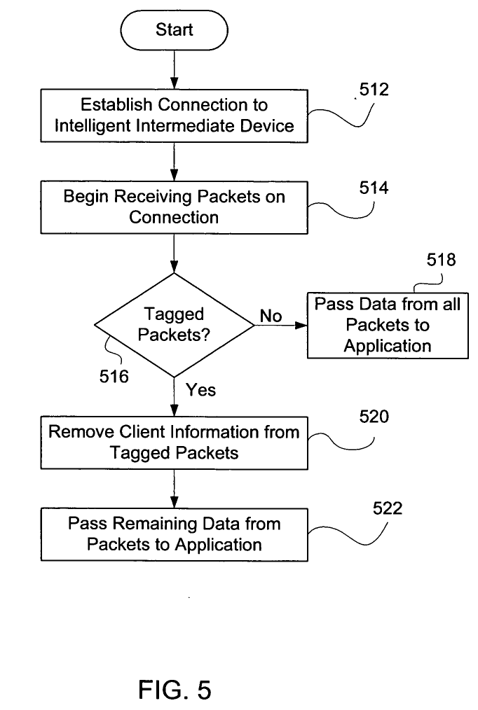

FIG. 5 is a flowchart of method steps for deriving client identifying information, in accordance with one embodiment of the invention. In step 512, source-identifying server 118 establishes a connection to intelligent intermediate device 114. In step 514, source-identifying server 118 begins receiving packets of a data stream on the connection. In step 516, interceptor 414 looks at the data in the first few packets to determine whether the packets are tagged packets. If interceptor 414 does not recognize any tagged packets, the method continues to step 518, where interceptor 414 passes all of the data from the packets on the connection to application 412 with no modifications.

If interceptor 414 does recognize at least one tagged packet, in step 520 interceptor 414 removes the client identifying information from the tagged packets until all the client identifying information has been read. In step 522, interceptor 414 passes the remaining data from the packets on the connection to application 412.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A system comprising:
an intelligent intermediate device with an input and an output,
the input of the intelligent intermediate device capable of receiving a client communication, wherein the client communication includes client identifying information,
the output of the intelligent intermediate device capable of sending a server communication,
the intelligent intermediate device including a tagger, the tagger capable of receiving the client identifying information and generating a tagged data stream capable of being included in the server communication, the tagged data stream including derivable client identifying information; and
an interceptor configured to derive the client identifying information from the tagged data stream in the server communication and provide the client identifying information to an application at the server.

2. The system of claim 1, wherein the tagger is configured to insert the client identifying information into a data field of at least one tagged packet.

3. The system of claim 1, wherein the tagger is configured to concatenate the client identifying information to communication data to create the tagged data stream.

4. The system of claim 1, wherein the tagger is configured to insert the client identifying information into a protocol header of at least one tagged packet.

5. The system of claim 4, wherein the tagger is further configured to insert the client identifying information into a TCP header of the at least one tagged packet.

6. The system of claim 4, wherein the tagger is further configured to insert the client identifying information in an IP header of the at least one tagged packet.

7. The system of claim 1, wherein the client identifying information includes a client IP address.

8. The system of claim 1, wherein the interceptor provides the client identifying information to the application by
intercepting a call from the application to an operating system of the server, the call including a request for the identity of the source of the server communication, and
replying to the intercepted call with a response that includes the client identifying information instead of the identity of the source of the server communication.

9. The system of claim 1, wherein the interceptor is further configured to provide communication data in the server communication to the application.

10. An intelligent intermediate device comprising:
a proxy that has as an input a client communication and has as an output a server communication on behalf of a client; and
a tagger that creates at least one tagged packet including derivable client identifying information capable of being included in the server communication.

11. The intelligent intermediate device of claim 10, wherein the tagger is configured to insert the client identifying information into a data field of at least one tagged packet.

12. The intelligent intermediate device of claim 10, wherein the tagger is configured to concatenate the client identifying information to server communication data and to packetize the resulting data such that the client identifying information is inserted into a data field of at least one tagged packet.

13. The intelligent intermediate device of claim 10, wherein the tagger is configured to insert the client identifying information into a protocol header of at least one tagged packet.

14. The intelligent intermediate device of claim 13, wherein the tagger is configured to insert the client identifying information into a TCP header of the at least one tagged packet.

15. The intelligent intermediate device of claim 13, wherein the tagger is configured to insert the client identifying information into an IP header of the at least one tagged packet.

16. The intelligent intermediate device of claim 10, wherein the client identifying information includes a client IP address.

17. A source-identifying server comprising:
an operating system configured to receive a server communication from an intelligent intermediate device, the server communication including at least one tagged packet that includes client identifying information;
an application configured to receive data from the server communication; and
an interceptor configured to derive the client identifying information from the tagged packet;
the interceptor further configured
to intercept a call from the application to the operating system, the call requesting identifying information of the source of the server communication, and
to reply to the intercepted call with a response that includes the client identifying information in place of the identifying information of the source of the server communication.

18. The source-identifying server of claim 17, wherein the application is a web server.

19. The source-identifying server of claim 17, wherein the application is an email server.

20. The source-identifying server of claim 17, wherein the client identifying information includes a client IP address.

21. The source-identifying server of claim 17, wherein the server communication from the intelligent intermediate device includes cryptographically secure data.

22. The source-identifying server of claim 17, wherein the at least one tagged packet includes the client identifying information in a data field.

23. The source-identifying server of claim 17, wherein the at least one tagged packet includes the client identifying information in a protocol header.

24. The source-identifying server of claim 23, wherein the at least one tagged packet includes the client identifying information in a TCP header.

25. The source-identifying server of claim 23, wherein the at least one tagged packet includes the client identifying information in an IP header.

26. The source-identifying server of claim 17, wherein the interceptor is installed within an application processing environment to override at least one standard library function.

27. The source-identifying server of claim 17, wherein the interceptor is installed as a loadable module within the operating system.

28. A method comprising:
creating at least one tagged packet that includes client identifying information as a packet of a communication to be sent to a server;
sending the communication to the server;
recognizing the at least one tagged packet in the communication;
deriving the client identifying information from the at least one tagged packet; and
providing the client identifying information to an application at the server.

29. The method of claim 28, wherein the step of creating at least one tagged packet includes inserting the client identifying information in a data field of the at least one tagged packet.

30. The method of claim 28, wherein the step of creating at least one tagged packet includes concatenating the client identifying information to communication data and packetizing the resulting data such that the client identifying information is inserted into a data field of the at least one tagged packet.

31. The method of claim 28, wherein the step of creating at least one tagged packet includes inserting the client identifying information in a protocol header of the at least one tagged packet.

32. The method of claim 31, wherein the step of creating at least one tagged packet includes inserting the client identifying information in a TCP header of the at least one tagged packet.

33. The method of claim 31, wherein the step of creating at least one tagged packet includes inserting the client identifying information in a IP header of the at least one tagged packet.

34. The method of claim 28, wherein the step of providing the client identifying information to the application includes
intercepting a call from the application to an operating system of the server, the call including a request for the identity of the source of the communication, and
replying to the intercepted call with a response that includes the client identifying information instead of the identity of the source of the communication.

35. The method of claim 28, further comprising providing original communication data to the application.
